(19) United States
(12) Patent Application Publication
(10) Pub. No.: US 2025/0058570 A1
(43) Pub. Date: Feb. 20, 2025

(54) ROLL-TO-ROLL PRINTER

(71) Applicant: Procolored Technology Inc

(72) Inventor: Jiangyu WU, Shenzhen (CN)

(21) Appl. No.: 18/934,748

(22) Filed: Nov. 1, 2024

(30) Foreign Application Priority Data
Sep. 2, 2024 (CN) 202422142299.6

(51) Int. Cl. B41J 11/00; B41J 15/04; B41J 25/00

(52) U.S. Cl. CPC B41J 11/0095; B41J 11/003; B41J 15/042; B41J 25/001

(57) ABSTRACT

A roll-to-roll printer includes a storage portion for storing a substrate in a rolled form, a transport portion, a printing platform, a printing mechanism including a drive unit and a print head provided on the drive unit, and a detection sensor. The transport portion is configured for continuously transporting the substrate forward. The printing platform is configured for holding the substrate transported by the transport portion. The printing mechanism is provided above the printing platform. The drive unit can drive the print head to move in a direction orthogonal to the substrate feed direction. The detection sensor is provided on the drive unit, and is electrically connected to the drive unit. The drive unit can drive the detection sensor to move in the direction orthogonal to the substrate feed direction to detect the substrate height.

### CROSS-REFERENCE TO RELATED APPLICATIONS

This application claims the benefit of priority from Chinese Patent Application No. 202422142299.6 filed on Sep. 2, 2024. The content of the aforementioned application, including any intervening amendments made thereto, is incorporated herein by reference in its entirety.

### TECHNICAL FIELD

This application relates to printing devices, and more particularly to a roll-to-roll printer.

### BACKGROUND

Printers have been widely popularized in our daily life. There are many types of printers on the market, including ultraviolet (UV) LED inkjet printers which are full-color digital printers without plate-making. These printers can perform photo-quality color printing on the surfaces of various objects, such as T-shirts, glass, panels, and films. For example, printers can print the desired text and graphics onto a substrate (i.e., object) to form the desired patterns.

When printing (e.g., direct-to-film (DTF) heat transfer printing) on films (such as transfer printing films), it is common to configure the substrate (e.g., film) in a roll to store more substrate. The printing is performed on the film surface while the film is fed from the feeding device. However, because of various factors such as jamming and friction, the film may experience slight warping when being fed out. Given that the print head is very close to the film surface, the protruding portion may be in contact with the print head, such that the ink mixture adsorbed on the film surface will contaminate the print head. In addition, the ink-spray hole is very tiny (typically ranging from 20 to 50 micrometers, and smaller than the human hair), such that if the print head is contaminated with the ink mixture, the ink-spray hole may become clogged, which is difficult to be cleaned.

### SUMMARY

In order to address the issues in the prior art, the disclosure provides a roll-to-roll printer, which can effectively prevent the print head from being in contact with the warping portion of the substrate.

This application provides a roll-to-roll printer, comprising:
a storage portion;
a transport portion;
a printing platform;
a printing mechanism; and
a detection sensor;
wherein the storage portion is configured to store a substrate in a rolled form;
the transport portion is provided adjacent to the storage portion, and is configured to continuously transport the substrate forward from the storage portion;
the printing platform is provided adjacent to the transport portion, and is configured to hold the substrate transported by the transport portion;
the printing mechanism is provided above the printing platform, and comprises a drive unit and a print head arranged at the drive unit; and the drive unit is configured to drive the print head to move in a direction orthogonal to a direction in which the substrate is transported; and
the detection sensor is provided on the drive unit, and is electrically connected to the drive unit; the drive unit is also configured to drive the detection sensor to move in the direction orthogonal to the direction in which the substrate is transported; and the detection sensor is configured to detect a height of the substrate.

In the present disclosure, the detection sensor is introduced to measure the height of the substrate, such that when the substrate (e.g., film) warps and exceeds a preset height, a signal is output based on an input from the detection sensor to stop the operation of the printing mechanism, preventing the print head from being in contact with the warping area of the substrate.

In some embodiments, the printing mechanism further comprises a mounting base configured to mount the print head; and the detection sensor is provided at the mounting base.

In some embodiments, the detection sensor is a non-contact sensor.

In some embodiments, the detection sensor is a photoelectric sensor based on light reflection by an ink.

In some embodiments, the detection sensor is provided in plurality, and a plurality of detection sensors are arranged at intervals along the direction in which the substrate is transported.

In some embodiments, the plurality of detection sensors are provided at a side of the print head along the direction orthogonal to the direction in which the substrate is transported.

In some embodiments, the mounting base is provided with an avoidance groove, and the avoidance groove is configured to run through a lower surface of the mounting base; and a surface of the print head where an ink-spray hole is arranged is configured to expose from the avoidance groove without protruding from the lower surface of the mounting base.

In some embodiments, a distance between the lower surface of the mounting base and the surface of the print head where the ink-spray hole is arranged is 0.3-1 mm along an ink ejection direction.

In some embodiments, two sides of the printing platform in the direction orthogonal to the direction in which the substrate is transported are each provided with a limiting plate, and the limiting plate is configured to restrict the movement of the substrate along an ink ejection direction of the print head; and
the limiting plate comprises a limiting portion, and a gap is provided between the limiting portion and an upper surface of the printing platform to allow the substrate to pass through.

In some embodiments, the printing platform is provided with a mounting groove, and the mounting groove is configured to extend in the direction orthogonal to the direction in which the substrate is transported; and
the limiting plate is adjustably provided on the printing platform through the mounting groove in the direction orthogonal to the direction in which the substrate is transported.

### BRIEF DESCRIPTION OF THE DRAWINGS

FIG. 1 is a perspective view of a roll-to-roll printer in accordance with an embodiment of the present disclosure viewed from the right side;

FIG. 2 is a perspective view of the roll-to-roll printer in FIG. 1 viewed from the left side;

FIG. 3 is a perspective view of the roll-to-roll printer in FIG. 1 viewed from the rear side;

FIG. 4 schematically shows a limiting plate in accordance with an embodiment of the present disclosure; and

FIG. 5 schematically shows a mounting base of a printing mechanism of FIG. 1 and components provided on the mounting base.

### DETAILED DESCRIPTION OF EMBODIMENTS

The technical solutions of the present disclosure will be described clearly and completely below in conjunction with the embodiments to make those skilled in the art fully understand the objectives, features, and beneficial effects of the present disclosure. It is obvious that described herein are merely some embodiments of the present disclosure, rather than all embodiments of the present disclosure. Based on the embodiments provided herein, all other embodiments obtained by those of ordinary skill in the art without making creative effort shall fall within the scope of the present disclosure defined by the appended claims.

In the description of the embodiments of the present disclosure, the orientation or position relationship indicated by terms such as “up”, “down”, “front”, “back”, “left” and “right” is based on the those shown in the accompanying drawings. These terms are solely for the convenience of describing the present disclosure, and are not intended to indicate or imply that the devices or components must have specific orientations or be constructed and operated in specific orientations. Therefore, these terms should not be understood as limitations of the present disclosure.

In the description of the present disclosure, if a certain feature is described to be “provided”, “fixed”, “connected” or “mounted” on another feature, it may be directly provided, fixed, connected, or mounted on another feature, or indirectly provided, fixed, connected, or mounted on another feature. As used herein, the term “several” refers to one or more; and term “multiple” refers to two or more. Terms such as “greater than”, “less than” or “exceeding” should be understood to exclude the specified value. Terms such as “above”, “below” or “within” should be understood to include the specified value. Terms “first” and “second” are merely used to distinguish technical features, rather than indicating or implying relative importance or implicitly suggesting the quantity of the technical features referred to or the sequence of the indicated technical features.

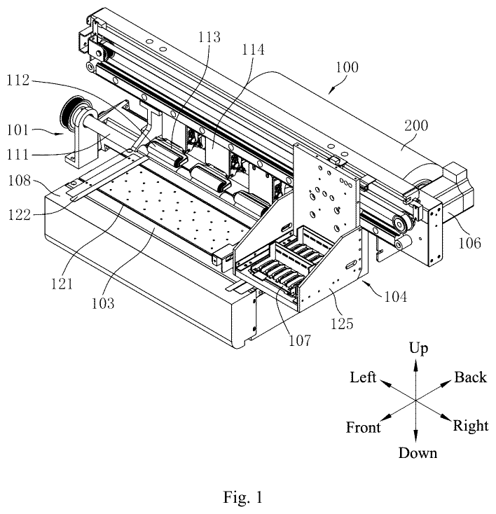

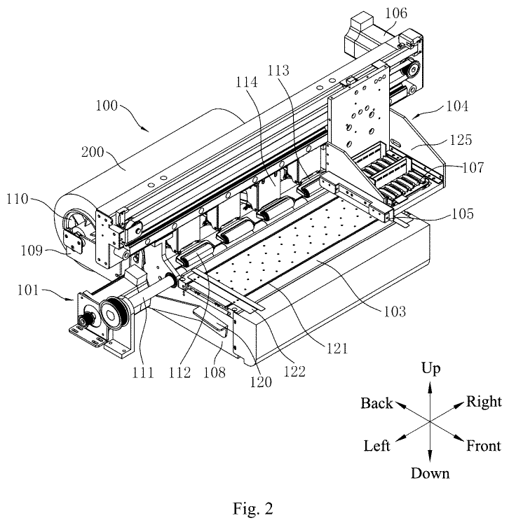

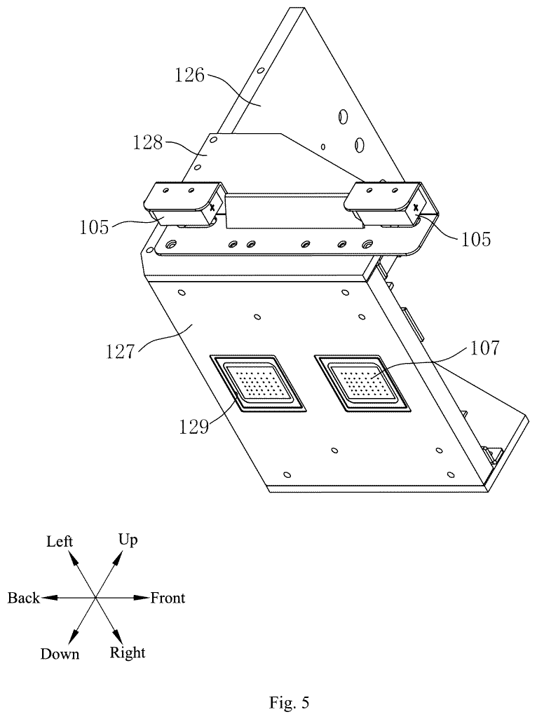

As shown in FIGS. 1-5, particularly in FIGS. 1-2, an embodiment of the present application provides a roll-to-roll printer, including a storage portion 100, a transport portion 101, a printing platform 103, a printing mechanism 104, and a detection sensor 105. The storage portion 100 is configured to store a substrate 200 in a rolled form. The transport portion 101 is provided in front of the storage portion 100, and is configured to continuously transport the substrate 200 forward from the storage portion 100. The printing platform 103 is provided in front of the transport portion 101, and is configured to hold the substrate 200 transported by the transport portion 101. The printing mechanism 104 is provided above the printing platform 103, and includes a drive unit 106 and a print head 107. The print head 107 is provided on the drive unit 106. And the drive unit 106 is configured to drive the print head 107 to move in a direction orthogonal to the direction in which the substrate 200 is transported. The detection sensor 105 is provided on the drive unit 106, and is electrically connected to the drive unit 106. The drive unit 106 is configured to drive the detection sensor 105 to move in the direction orthogonal to the direction in which the substrate 200 is transported, and the detection sensor 105 is configured to detect a height of the substrate 200.

In this embodiment, the detection sensor 105 is introduced to measure the height of the substrate 200, such that when the substrate 200 (e.g., film) warps and exceeds a preset height, a signal is output based on an input from the detection sensor 105 to stop the operation of the printing mechanism 104, preventing the print head 107 from being in contact with the warping area of the substrate 200.

Specifically, in an embodiment, the distance at which the print head 107 can achieve the high-quality printing on the surface of the substrate 200 is 2-2.5 mm, that is, the surface of the print head 107 where an ink-spray hole is arranged is positioned at a distance of 2-2.5 mm from the surface of the substrate 200. When the height of the warping area of the substrate 200 exceeds 2.5 mm (i.e., the preset height), the substrate 200 may be in contact with the surface of the print head 107 where an ink-spray hole is arranged, such that the print head 107 may be contaminated with the ink mixture adhering to the surface of the substrate 200. In an embodiment, the drive unit 106 can simultaneously drive the print head 107 and the detection sensor 105, so as to maintain the detection sensor 105 in a state of detecting the height of the to-be-printed area of the substrate 200. When it is detected by the detection sensor 105 that the height of a certain area of the substrate 200 exceeds 2.5 mm, it sends a signal to the controller (not shown in the figures), and then the controller outputs a signal to stop the drive unit 106 from driving the print head 107, so as to prevent the print head 107 from being in contact with the warping portion of the substrate 200 with a height exceeding 2.5 mm. Additionally, the controller can also output an alarm signal to alert the operator to perform active intervention, such as manually flattening and resetting the substrate.

Additionally, it should be noted that the controller outputs signals to control the on/off actions of other actuators based on the input signals from the detection sensor 105, which is electrically connected to the controller. These control methods are common knowledge and are not within the scope of the present disclosure, therefore, they will not be elaborated here.

In an embodiment, the roll-to-roll printer includes a printer main body 108, with a printing area provided in a center of the printer main body 108. The storage portion 100 is provided on a rear side of the printer main body 108, that is, the storage portion 100 is provided on the rear side of the printing area. The storage portion 100 includes two support frames 109 provided at intervals in the left and right directions on the rear side of the printer main body 108. The substrate 200 is held in a wound state on the core shaft 110 when in a material feeding state. Additionally, the substrate 200 is rotatably held on the support frame 109 through the core shaft 110.

The transport portion 101 includes a first clamping roller 111 and a plurality of second clamping rollers 112 that are provided opposite each other in a vertical direction. The first clamping roller 111 is rotatably provided in the lower portion of the printer main body 108, and is configured to extend in the left and right directions of the printer main body 108 and span the entire printing area. The first clamping roller 111 is configured to drive by a motor (not shown in the figures, such as a stepping motor or a servo motor). The plurality of second clamping rollers 112 are provided above the first clamping roller 111, and are provided at intervals along the left and right directions of the printer main body 108. The plurality of second clamping rollers 112 are swingably provided above the printer main body 108 through swing arms 113. The swing arms 113 are swingably provided above the printer main body 108 through mounting arms 114. The plurality of second clamping rollers 112 are rotatably provided in front of the swing arms 113. Additionally, a tension spring 115 is configured to hold a rear end of the swing arms 113 upwardly, such that a downward force is applied at a front end of the swing arms 113, so that the second clamping rollers 112 at the front end of the swing arms 113 is abutted against the first clamping roller 111.

The to-be-transported substrate 200 is provided between the first clamping roller 111 and the plurality of second clamping rollers 112 in the vertical direction. The tension spring 115 is configured to hold the rear end of the swing arm 113, such that the first clamping roller 111 and the plurality of second clamping rollers 112 can maintain a clamping state of the substrate 200. When the motor drives the first clamping roller 111, the substrate 200 clamped by the first clamping roller 111 and the plurality of second clamping rollers 112 is continuously transport forward with a rotation of the first clamping roller 111.

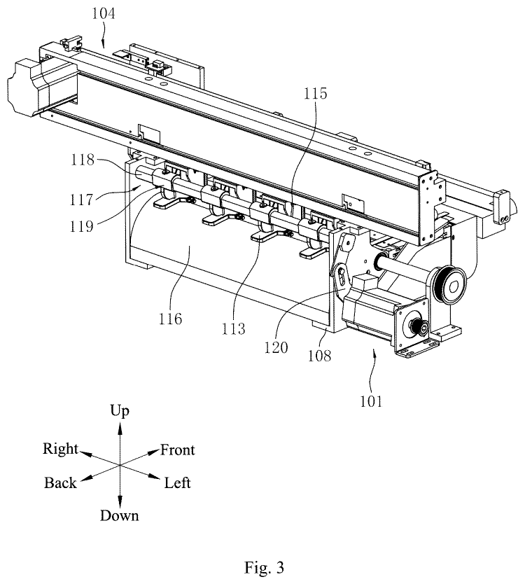

As shown in FIG. 3 in combination with FIGS. 1-2, a guide plate 116 is provided between the storage portion 100 and the transport portion 101. The substrate 200 transported from the storage portion 100 is configured to direct by the guide plate 116 and pass through the first clamping roller 111 and the plurality of second clamping rollers 112 of the transport portion 101, such that the substrate 200 can reach the printing platform 103 provided in front of the transport portion 101.

As shown in FIGS. 1-3, to facilitate the mounting and removal of the substrate 200, an embodiment of the present disclosure further includes a separation mechanism 117 for separating the plurality of second clamping rollers 112 from the first clamping roller 111. The separation mechanism 117 includes a rotating rod 118, a plurality of separation cams 119 and a handle 120. The rotating rod 118 is configured to extend in the left and right directions, and is rotatably provided on the printer main body 108. The plurality of separation cams 119 are provided at intervals along the rotating rod 118 in the left and right directions. Furthermore, each of the plurality of separation cams 119 is corresponded one-to-one with the plurality of swing arms 113, and each separation cam 119 abuts against the rear end of its corresponding swing arms 113. The handle 120 is provided on an outer side of the printer main body 108, and is connected to the rotating rod 118. When the handle 120 is swung, the rotating rod 118 is rotated, such that the separation cam 119 rotates around the rotating rod 118. Additionally, as the separation cam 119 rotates, it presses down on the second end of the swing arm 113 to overcome the force of the tension spring 115, such that the front end of the swing arm 113 swings upwardly, separating the second clamping rollers 112 from the first clamping roller 111. In a state where the second clamping rollers 112 and the first clamping roller 111 are separated in the vertical direction, the substrate 200 can be easily mounting and removed as needed.

The printing platform 103 is provided approximately at a center of the printing area of the printer main body 108, and is provided in front of the transport portion 101. The substrate 200 transported forward by the transport portion 101 is held on the printing platform 103. In some embodiments, the printing platform 103 is in a plate shape, and is provided across the left and right directions of the printer main body 108. The printing platform 103 is provided with a mounting groove 121, and the mounting groove is configured to extend in the direction orthogonal to the direction in which the substrate 200 is transported (shown as left and right directions in the figures). In some embodiments, the mounting groove 121 is a T-groove, and is configured to extend through the printing platform 103 in the left and right directions.

Two sides of the printing platform 103 in the direction orthogonal to the direction in which the substrate 200 is transported (shown as left and right directions in the figures) are each provided with a limiting plate 122. The limiting plate 122 is configured to restrict the movement of the substrate 200 along an ink ejection direction of the print head 107. The limiting plate 122 is adjustably provided on the printing platform 103 in a direction orthogonal to the direction in which the substrate 200 is transported (shown as left and right directions in the figures) through the mounting groove 121. The mounting positions of the two limiting plates 122 are not specifically limited, as long as they do not interfere with the transportation of the substrate 200, and the two limiting plates 122 can restrict the movement of the substrate 200 in the vertical direction. In some embodiments, the limiting plates 122 are made from thin metal plates and bent into a roughly Z-shape. In some embodiments, each limiting plate 122 includes a base 123 and a limiting portion 124. The base 123 is provided in the mounting groove 121 of the printing platform 103 through T-bolts. Furthermore, when the base 123 is in contact with an upper surface of the printing platform 103, a gap is formed between the limiting portion 124 and the upper surface of the printing platform 103, such that the substrate 200 can pass through. In some embodiments, a height of the gap is 0.8-1.2 mm. In some embodiments, a length of the limiting portion 124 that extends in the left and right directions is 5-15 mm.

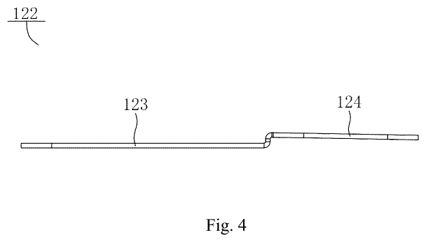

As shown in FIGS. 1 and 4, by means of limiting plates 122, it is possible to restrict and guide the substrate 200 provided on the printing platform 103, thereby preventing the substrate 200 from warping due to misalignment. In some embodiments, the gap that allows the substrate 200 to pass through is 0.8-1.2 mm, it is possible to facilitate the smooth passage of the substrate 200 while suppressing excessive warping of the middle portion of the substrate 200 in the left and right directions. In an embodiment, when the gap is less than 0.8 mm, a space for the vertical movement of the substrate 200 on the printing platform 103 is too small to make the substrate 200 get stuck on the printing platform 103. Conversely, when the gap exceeds 1.2 mm, it results in excessive vertical movement space for the substrate 200 on the printing platform 103, potentially causing the substrate 200 to warp excessively at the middle portion of the printing platform 103. In some embodiments, the length of the limiting portion 124 is 5-15 mm, allowing for reliable restriction of the substrate 200 while reducing an obscured area of the substrate 200. When the length of the limiting portion 124 is less than 5 mm, it may result in the limiting portion 124 being unable to reliably restrict the substrate 200, causing the substrate 200 to slip out from the gap. Conversely, when the length of the limiting portion 124 exceeds 15 mm, it may excessively obscure the substrate 200, thus affecting the printable area of the substrate 200. Furthermore, by making the limiting plates 122 adjustable in the left and right directions on the printing platform 103, it is possible to accommodate the width of the substrate 200, thereby enhancing a versatility of the roll-to-roll printer.

The printing mechanism 104 is provided on an upper portion of the printer main body 108. The printing mechanism 104 includes a single-axis manipulator (not shown in the figures), and the single-axis manipulator serves as the drive unit 106, and is configured to move in the left and right directions. In some embodiments, the single-axis manipulator can be a commercially available slide module driven by a motor, or it can be the single-axis manipulator provided on the upper portion of the printer main body 108 with guide rails and a synchronous belt transmission mechanism. A driving stroke of the single-axis manipulator spans the entire printing area.

As shown in FIGS. 1, 2, and 5, the printing mechanism 104 further includes a mounting base 125 for mounting the print head 107. The mounting base 125 is provided on a slide block (not shown in the figures) of the single-axis manipulator serving as the drive unit 106. The mounting base 125 includes a first plate 126, a second plate 127, and a reinforcing plate 128. The first plate 126 is directly provided on the slide block. The second plate 127 is provided on a lower side of the first plate 126, and two sides of the first plate 126 and the second plate 127 are each provided with the reinforcing plates 128.

The mounting base 125 is provided with an avoidance groove 129, and the avoidance groove 129 is configured to run through a lower surface of the mounting base 125. A surface of the print head 107 where an ink-spray hole is arranged is configured to expose from the avoidance groove 129 without protruding from the lower surface of the mounting base 125. The avoidance groove 129 is provided within the second plate 127 of the mounting base 125, and is configured to extend vertically through the second plate 127. The print head 107 is provided on the second plate 127 of the mounting base 125. The print head 107 is embedded within the avoidance groove 129, and the surface of the print head 107 where an ink-spray hole is arranged (not shown in the figures) facing downward. Furthermore, the surface of the print head 107 where an ink-spray hole is arranged does not protrude from a lower surface of the second plate 127 of the mounting base 125. In an embodiment, a distance between the lower surface of the second plate 127 of the mounting base 125 and the surface of the print head 107 where an ink-spray hole is arranged is 0.3-1 mm along an ink ejection direction (in the vertical direction). That is, when printing on the surface of the substrate 200, the distance between the lower surface of the second plate 127 and the surface of the substrate 200 is less than the distance between the surface of the print head 107 where an ink-spray hole is arranged and the surface of the substrate 200. As a result, even if the substrate 200 warps, it will still be in contact with the lower surface of the second plate 127, so as to prevent the substrate 200 from being in contact with the surface of the print head 107 where an ink-spray hole is arranged. Furthermore, by maintaining this distance at greater than 0.3 mm, it is possible to reliably suppress the situation where the substrate 200 is in contact with both the lower surface of the second plate 127 and the surface of the print head 107 where an ink-spray hole is arranged. By setting this distance to be less than 1 mm, it is possible to slightly increase the distance between the lower surface of the second plate 127 and the surface of the substrate 200. In an embodiment, the distance at which the print head 107 can achieve the high-quality printing on the surface of substrate 200 is 2-2.5 mm. This distance (2-2.5 mm) equals the distance between the lower surface of the second plate 127 and the surface of the substrate 200, plus the distance between the lower surface of the second plate 127 and the surface of the print head 107 where an ink-spray hole is arranged. By maintaining the distance of less than 1 mm between the lower surface of the second plate 127 and the surface of the print head 107 where an ink-spray hole is arranged, the distance between the lower surface of the second plate 127 and the surface of the substrate 200 can be ensured to be 1-2.2 mm. Thus, it is possible to slightly increase the distance between the lower surface of the second plate 127 and the surface of the substrate 200, so as to prevent the drive unit 106 from driving the mounting base 125 to move and collide with the substrate 200.

The detection sensor 105 is provided on the mounting base 125. More specifically, the detection sensor 105 is provided on the side of the print head 107 in the direction orthogonal to the direction in which the substrate 200 is transported (shown as left and right directions in the figures). Furthermore, relative to the print head 107, the detection sensor 105 is provided on the advancing side of the drive unit 106 in a direction of movement during printing. That is, in an embodiment, as shown in the FIGS. 1 and 2, when the drive unit 106 drives the print head 107 to print in the left direction, the detection sensor 105 is provided on a left side of the print head 107. In an embodiment, the detection sensor 105 is provided on a left side of the reinforcing plate 128 of the mounting base 125. Relative to the print head 107, by providing the detection sensor 105 on the advancing side of the drive unit 106 in the direction of movement during printing, it ensures that the detection sensor 105 is positioned above the substrate 200 before the print head 107 reaches it. This setup allows for an early detection of whether the substrate 200 is warped, so as to prevent the warped substrate 200 from being in contact with the warping area of the substrate 200.

In some embodiments, the detection sensor 105 is a non-contact sensor. As a non-contact sensor, the detection sensor 105 can be a reflective photoelectric sensor or a through-beam photoelectric sensor. As the reflective photoelectric sensor, the detection sensor 105 can be the photoelectric sensor light reflection caused by an ink. Since the substrate 200 may be transparent, the photoelectric sensor that relies on the light reflection by the ink can enhance the sensitivity of the detection sensor 105.

In some embodiments, the detection sensor 105 is provided in plurality, and a plurality of detection sensors 105 are arranged at intervals along the direction in which the substrate 200 is transported. In an embodiment, the number of the detection sensor 105 is two, and two detection sensors 105 are spaced apart in a front and rear directions. In an embodiment, the two detection sensors 105 are distributed such that a first detection sensor 105 is provided on a rear side of the print head 107, while a second detection sensor 105 is provided on a front side of the print head 107. That is, the detection sensors 105 are arranged in the front and rear directions spanning the printing area of the print head 107. This allows for early detection of whether the substrate 200 is warped along its transporting direction, as well as detection of whether the substrate 200 is warped after printing. Therefore, it is possible to extend the detection range of the detection sensor 105 and prevent the warping area of the substrate 200 from being in contact with the surface of the print head 107.

In the specific embodiments described above, various technical features described can be combined in any manner as long as there is no contradiction. To avoid unnecessary repetition, the disclosure does not provide further explanations regarding the possible combinations.

The embodiments described above are merely illustrative of the present disclosure, and are not intended to limit the scope of the present disclosure. It should be understood that various changes or substitutions made by those of ordinary skill in the art without departing from the spirit of the present disclosure shall fall within the scope of the present disclosure defined by the appended claims.

What is claimed is:

1. A roll-to-roll printer, comprising:
a storage portion;
a transport portion;
a printing platform;
a printing mechanism; and
a detection sensor;
wherein the storage portion is configured to store a substrate in a rolled form;
the transport portion is provided adjacent to the storage portion, and is configured to continuously transport the substrate forward from the storage portion;
the printing platform is provided adjacent to the transport portion, and is configured to hold the substrate transported by the transport portion;
the printing mechanism is provided above the printing platform, and comprises a drive unit and a print head arranged at the drive unit; and the drive unit is configured to drive the print head to move in a direction orthogonal to a direction in which the substrate is transported; and
the detection sensor is provided on the drive unit, and is electrically connected to the drive unit; the drive unit is also configured to drive the detection sensor to move in the direction orthogonal to the direction in which the substrate is transported; and the detection sensor is configured to detect a height of the substrate.

2. The roll-to-roll printer of claim 1, wherein the printing mechanism further comprises a mounting base configured to mount the print head; and the detection sensor is provided at the mounting base.

3. The roll-to-roll printer of claim 2, wherein the detection sensor is a non-contact sensor.

4. The roll-to-roll printer of claim 3, wherein the detection sensor is a photoelectric sensor based on light reflection caused by an ink.

5. The roll-to-roll printer of claim 2, wherein the detection sensor is provided in plurality, and a plurality of detection sensors are arranged at intervals along the direction in which the substrate is transported.

6. The roll-to-roll printer of claim 5, wherein the plurality of detection sensors are provided at a side of the print head along the direction orthogonal to the direction in which the substrate is transported.

7. The roll-to-roll printer of claim 2, wherein the mounting base is provided with an avoidance groove, and the avoidance groove is configured to run through a lower surface of the mounting base; and a surface of the print head where an ink-spray hole is arranged is configured to expose from the avoidance groove without protruding from the lower surface of the mounting base.

8. The roll-to-roll printer of claim 7, wherein a distance between the lower surface of the mounting base and the surface of the print head where the ink-spray hole is arranged is 0.3-1 mm along an ink ejection direction.

9. The roll-to-roll printer of claim 1, wherein two sides of the printing platform in the direction orthogonal to the direction in which the substrate is transported are each provided with a limiting plate, and the limiting plate is configured to restrict the movement of the substrate along an ink ejection direction of the print head; and
the limiting plate comprises a limiting portion, and a gap is provided between the limiting portion and an upper surface of the printing platform to allow the substrate to pass through.

10. The roll-to-roll printer of claim 9, wherein the printing platform is provided with a mounting groove, and the mounting groove is configured to extend in the direction orthogonal to the direction in which the substrate is transported; and
the limiting plate is adjustably provided on the printing platform through the mounting groove in the direction orthogonal to the direction in which the substrate is transported.
